(19) United States
(12) Patent Application Publication
(10) Pub. No.: US 2021/0323734 A1
(43) Pub. Date: Oct. 21, 2021

(54) VALVED TUBE

(71) Applicant: Eric ZEMBROD, Boituva (BR)

(72) Inventor: Eric ZEMBROD, Boituva (BR)

(21) Appl. No.: 17/260,353

(22) PCT Filed: Jul. 17, 2018
(86) PCT No.: PCT/BR2018/050242

§ 371 Date: Jan. 14, 2021

(51) Int. Cl. B65D 35/46; A45D 34/04; A45D 40/26; B65D 35/10; B05B 11/04

(52) U.S. Cl. CPC B65D 35/46; A45D 34/041; B05B 11/047; B65D 35/10; A45D 40/261

(57) ABSTRACT

VALVED TUBE, consisting of: an intermediate mounting body (1) fixed to the toothed neck (2) of a tube (3) and surrounded by a cover (4); a tubular plunger (5); a plug (6), having its lower end integrated with the inner diameter of the upper end of the tubular plunger (5) and oriented to close or open a hole (7) in the recessed top of the product outlet cover (4); an automatic check valve (8) mounted on the inner and lower part of the intermediate mounting body (1), wherein said valve opens when there is internal pressure in the tube (3) and closes when it returns to its original position; a first flow controller (9) arranged inside the tubular plunger (5) and below the plug (6); and a second flow controller (10) arranged at the inter-superior end of the tubular plunger (5) and around the plug (6).

### FIELD OF THE INVENTION

More particularly the present Invention relates to tube type packaging, which container is manufactured in memory plastic material to return to its original shape after being pressed. The container body has its neck combined with a mechanism for controlling the product to be dispensed. In this mechanism the opening and closing are defined by an automatic lower valve and a manually actuated upper plug performed with a turn of a cover. When rotating the cover, the plug moves to the open position and then, when pressing the container, the lower valve is also moved to the open position, allowing the product to pass through. When the container is no longer pressed, the pressure ceases to exist and has a suction effect, causing the lower valve to be taken to the closed position, so that the plug can then be taken to the closed position. Providing a watertight closure without air intake.

On the other hand, between the manual actuation plug and the automatic valve, there are means for controlling the output flow of the product.

### STATE OF THE ART

Currently there are numerous packages with features similar to those mentioned above, as the following documents teach, for example: BR102014016689, BR102014016690, U.S. Pat. Nos. 6,745,781, 6,793,431, 7,309,184, 7,824,124, 8,226,319, 8,714,857, 6,685,062, 6,962,273, 7,938,298, 8,052,016, 8,499,970, 8,622,254, 8,631,975, 8,690,022, 8,863,988, 8,881,946, US2013108349, US20020014254, US20020090247, US20030057236, US20030057236 and CN103826753A. Logically each document describes a device with a peculiar construction to be used in different packages, so that its content of easy flowability, semi-solids, can be ejected and applied in the desired way, always to offer an efficient way in handling, control and application of the product.

The state of the art offers devices so that the contents of a package can be ejected and dispensed appropriately at any location. The product is usually a cosmetic or drug. Such devices are also developed for packages formed by rigid reservoir or in the form of flexible tubes or pipes. In both cases, complex valved mechanisms, some with springs and others with equivalent parts, are provided for when it is desired to prevent air intake (air less), and may also include components that function as a check valve.

Other devices that operate by a plunger system are also highlighted, where its operation promotes suction (vacuum) inside the packaging and forces the product out and, in this condition, prevents air from entering. This system is generally adopted in rigid packaging, however, there are variable techniques that allow its use in flexible packaging of relatively large size.

Known dispensing devices actually prevent air from entering the package, however, with the disadvantage of adding a considerable number of movable components such as: valves, plungers, buttons, triggers and others. Each design is limited with minimal sizing that typically does not meet packages of reduced size or capacity, such as those used in the cosmetics and drug sectors for beautifying or treating regions of the face, notably around the eyes.

Conventional devices also present as disadvantage the fact that they do not have means for precise flow control during product output. This inadequate control is further aggravated in packaging with reduced sizes, because, as is known, some treatments require minimal volumes of product with each application. It is notorious that the products exhibit a considerable range of viscosity and thus the flow behavior in small quantities in conventional packaging is not performed as desired.

In view of this, currently the packaging sector presents a disadvantageous gap due to the lack of a system that avoids air intake and that allows precise control of the product flow and also has a device with valves to be mounted on flexible packaging and that due to its differentiated shape enables a more appropriate application, consequently, when a particular package requires a device of such a nature, the known devices end up considerably increasing the final cost of the assembly and, even so, its use does not reach all the desired parameters.

### OBJECTS OF THE INVENTION

The first object of the invention is the realization of a tube with an outlet chamber that has internally three distinct product flow controls: a) two-point opening, one automatic and one manual; b) two-point tight closing, one automatic and one manual, and c) product flow control between the two opening and closing points.

The second object of the invention is to provide efficient means of watertight opening and closing, both carried out by an automatic lower valve and a manually actuated upper plug, the latter carried out with a turn of a cover. When rotating the cover, the plug moves to the open position and then, when pressing the container, the lower valve is also moved to the open position, allowing the product to pass through. When the container is no longer pressed, the pressure ceases to exist and has an inverse suction effect, causing the lower valve to be brought to the watertight position, so that the plug can then be brought to the closed position. Providing a watertight closure without air intake.

The third object of the invention is to provide means for controlling the flow of product between the lower valve and the upper plug. These means are components in the form of chokes, arranged at strategic points, each of them leaked by matching orifice so that the flow can be controlled, consequently it is possible to precisely control the amount of product dispensed.

The fourth object of the invention is a configuration so that the entire assembly, i.e., the valve, the plug and the chokes, are mounted in an outlet tubular chamber, characterizing an assembly with very reduced sizing, so that it can be mounted on tubes of reduced capacities normally used in the cosmetics, pharmaceuticals, food and chemical sectors.

The fifth object of the invention is to allow packages of reduced capacities to replace traditional pump-type flow control means or the like, consequently there is also a marked reduction in the final cost of the assembly.

As already mentioned, the present valved packaging was developed to have a small volume container, however, in laboratory tests it has been proven that its use in packaging with larger containers is also advantageous, especially with regard to the final cost.

### DESCRIPTION OF THE DRAWINGS

For a better understanding of the present Invention, a detailed description of it is given below, with references to the accompanying drawings:

FIG. 1 depicts a perspective view and a cross-sectional view, both partial, showing the assembled assembly;

FIG. 2 illustrates a top-angle exploded perspective showing in detail each component of the assembly;

FIG. 3 illustrates an exploded perspective at a lower angle, showing other details of each component;

FIG. 4 is an exploded perspective with two enlarged details, highlighting the plunger and the main body of the assembly;

FIG. 5 shows a cross-sectional view of the assembled assembly and an enlarged perspective detail also in section only of the cover;

FIG. 6 also depicts a cross-sectional view of the assembled assembly, however, accompanied by an enlarged detail of the check valve;

FIG. 7 cross-sectional view accompanied by an enlarged detail of one of the flow controllers;

FIG. 8 is a cross-sectional view accompanied by an enlarged detail of another flow controller;

FIG. 9 depicts a cross-sectional view of the assembled assembly showing a constructive variation of the cover; and

FIG. 10 shows an exploded perspective and a cross-sectional view, showing another constructive variation.

### DETAILED DESCRIPTION OF THE INVENTION

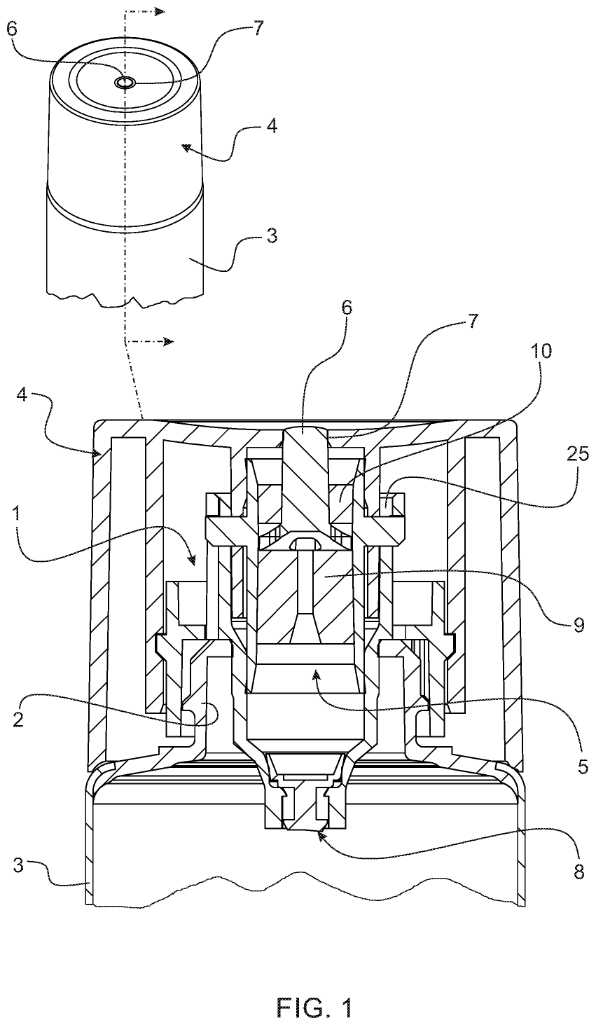

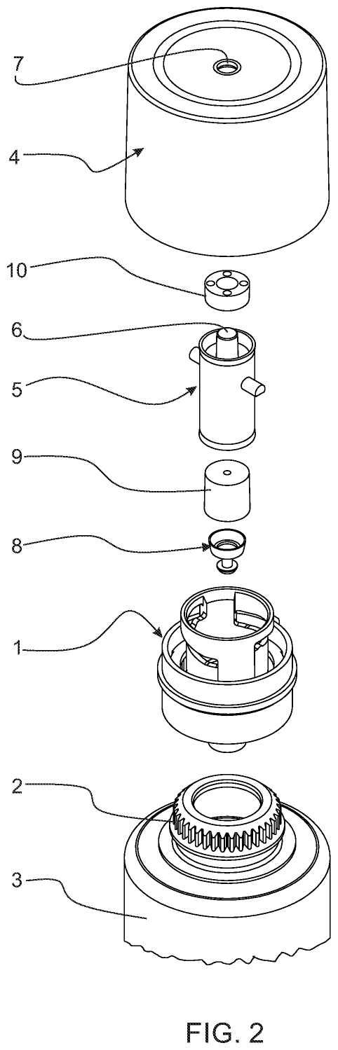

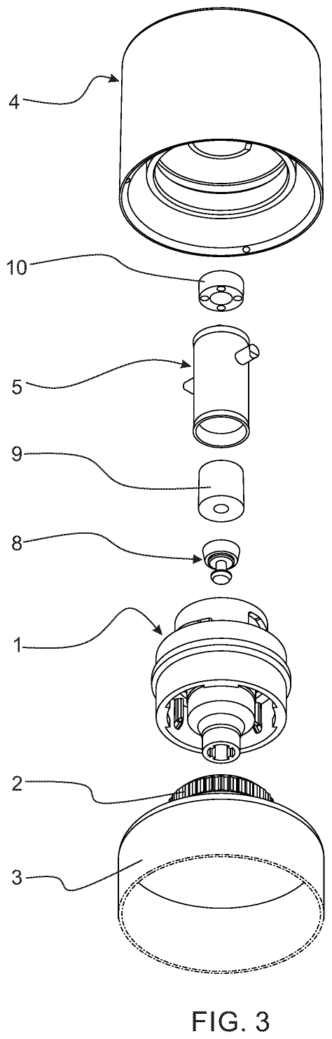

According to these illustrations and in their details, more particularly FIGS. 1, 2 and 3, the present Invention, VALVED TUBE, comprises:
intermediate mounting body (1), cylindrical, having the lower end fixed to the toothed neck (2) of a known tube (3) of the type made of plastic material to be pressed and with memory to return to its original position when it is no longer pressed;
a cover (4), cylindrical or oval and semi-rotatable in both directions, which encloses and is coupled to the upper side of the intermediate mounting body (1);
tubular plunger (5), whose inner diameter forms a passage chamber for the product, as it is also slidably mounted inside the intermediate mounting body (1) and is interconnected with the cover (4) to be moved up and down;
a plug (6), having its lower end integrated into the inner diameter of the upper end of the tubular plunger (5) and oriented to close or open a hole (7) in the recessed top of the product outlet cover (4);
an automatic check valve (8) mounted on the inner and lower part of the intermediate mounting body (1), where said valve is provided to open when there is internal pressure in the tube (3) and close when it returns to its original position;
a first flow controller (9) disposed within the tubular plunger (5) and below the plug (6); and
a second flow controller (10) disposed at the inter-superior end of the tubular plunger (5) and around the plug (6).

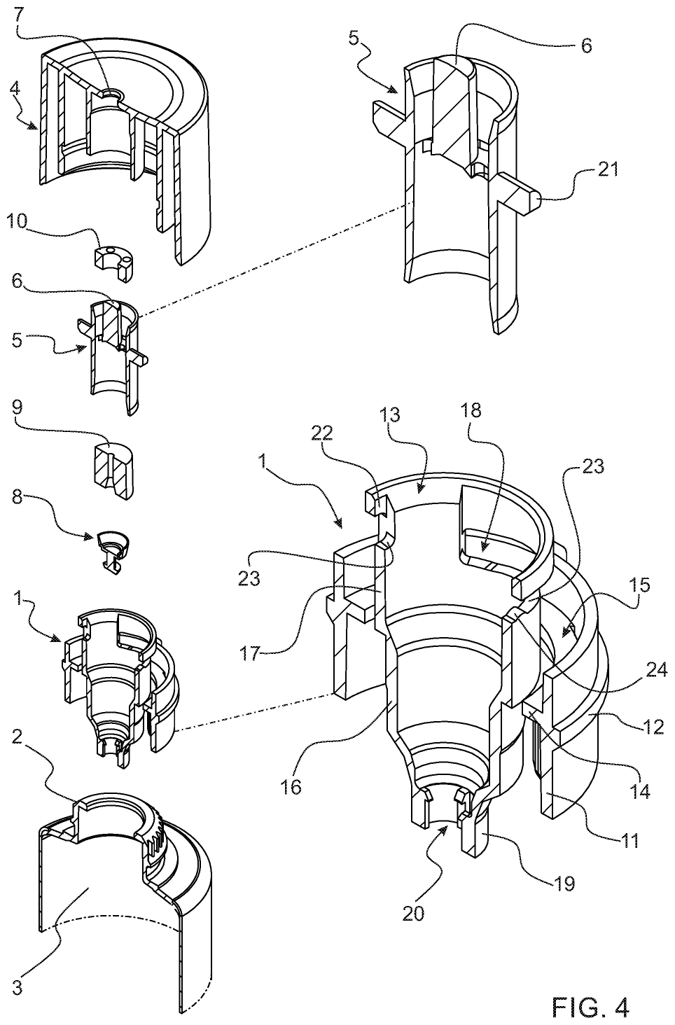

FIG. 4 shows in detail the intermediate mounting body (1), through which it is verified that it is formed by a first circular wall (11), whose outer diameter has annular shoulder (12) coupling to the cover (4) and cooperating so that it can undergo semi-rotations in both directions. The intermediate mounting body (1), on the inner side, centers a shell (13) interconnected with the first circular wall (11) by means of another radial wall (14), forming between both a spacing (15) housing the cover (4). Shell (13) has three diameters: an intermediate diameter (16) of sliding housing for tubular plunger (5); a larger upper diameter (17) with means (18) for coupling said tubular plunger (5) and cooperating so that it is moved up and down; and a smaller lower diameter (19), the latter forms an inner seat (20) for the automatic check valve (8), so that it can be moved up and open when internal pressure occurs in the known tube (3) and be moved down when the situation reverses, that is, when the known tube (3) is no longer pressed.

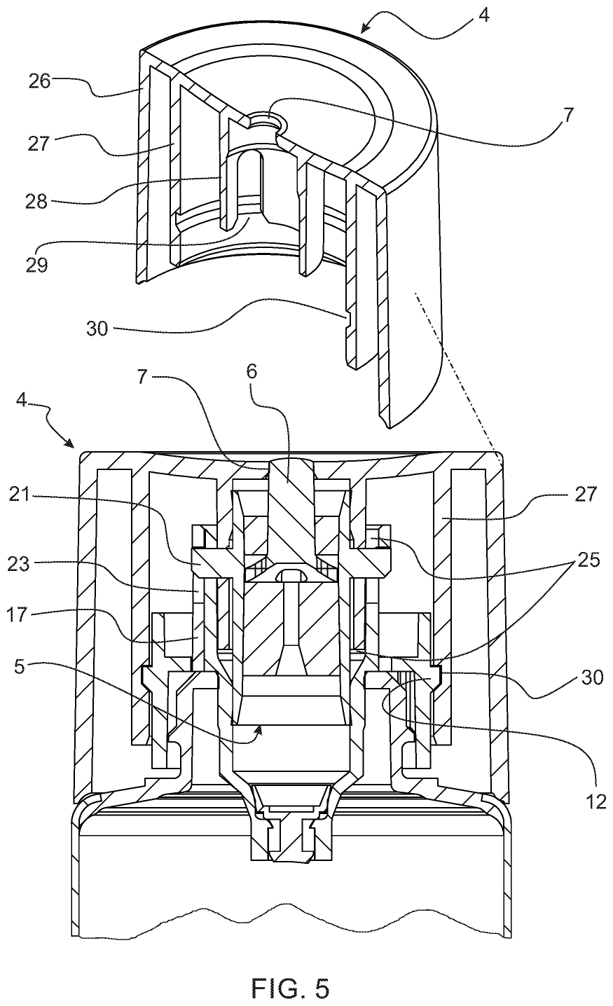

Still with respect to FIG. 4, the tubular plunger (5) presents its upper end with two radially opposite projections in the form of follower pins (21), which are coupled to the means (18) of the intermediate body (1) and, therefore, the shell (13) has its inner diameter with relief (22), oppositely located and, in these same regions, the wall of the shell (13) is leaked by tears that form cams (23), symmetrical, with their respective tops (24). In this condition, the tubular plunger (5) is fitted inside the shell (13), where the follower pins (21) forcibly pass through the reliefs (22) and are fitted into the cams (23), and at this point there is a spacing (25) (see FIG. 5) between the larger upper diameter (17) of the shell (13) and the tubular plunger (5), where coupling occurs between said tubular plunger (5) and the cover (4).

With respect to FIG. 5, the cover (4) is defined by three concentric walls, being an outer wall (26), an intermediate wall (27) and an inner wall (28) lower than the previous one, the latter engageable in that spacing (25), as well as having two opposing vertical tears (29), where the pins (21) of the tubular plunger (5) are coupled, while the intermediate wall (27) has its inner diameter equipped with a channel (30) fitting that annular shoulder (12), so that said cover can rotate in both directions, but is prevented from releasing axially.

The two-way turns of the cover (4) are transmitted to the pins (21) sliding on the cams (23) where said plunger is displaced up or down which allows opening or closing the outlet hole (7) of the product through the plug (6).

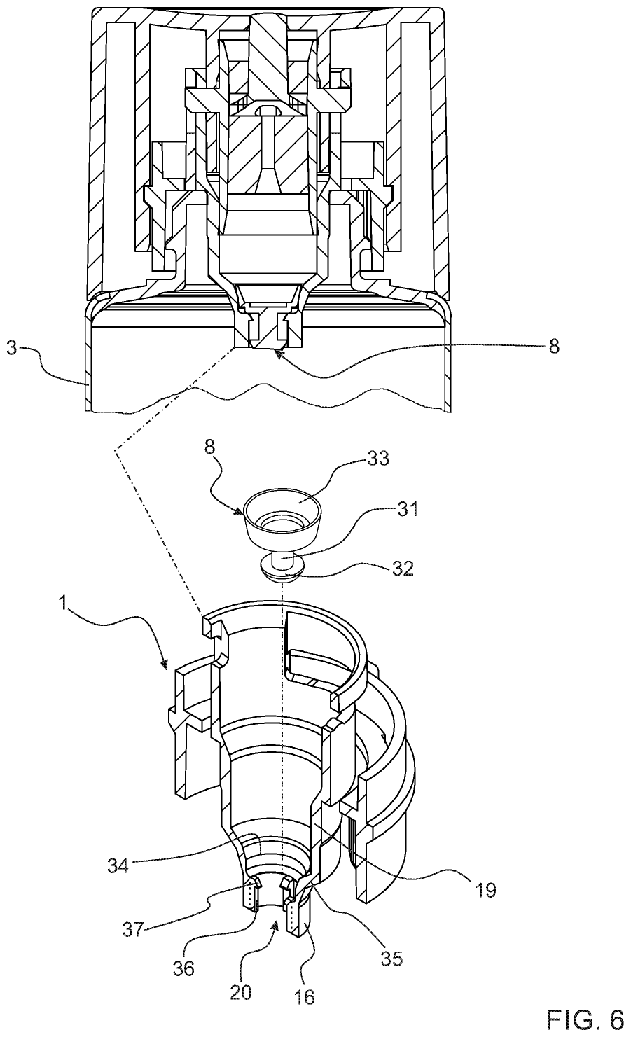

FIG. 6 shows the details of the automatic check valve (8), whereby it is found that it is formed in a single piece in the form of a cup, defined by a cylindrical central part (31), whose lower end widens and forms a frustoconical flange (32), while the upper end widens in the form of a frustoconical cup (33), which externally accommodates a sealing annular point (34) formed in the connecting section (35) between diameters (19) and (16) of the intermediate body (1). The automatic check valve (8) is retained inside the sealing seat (20) which further includes vertical ribs (36), whose upper ends are oriented radially inward and form retaining teeth (37), these with upper inclinations compatible with the tapered diameter of the flange (32), so that it passes between said teeth and is prevented from releasing again, but also between said teeth is positioned the cylindrical central part (31), whose height defines the stroke that determines the opening and closing of said automatic check valve (8), because, as has already been said, it is provided to open when there is internal pressure in the tube (3) and close when it returns to its original position.

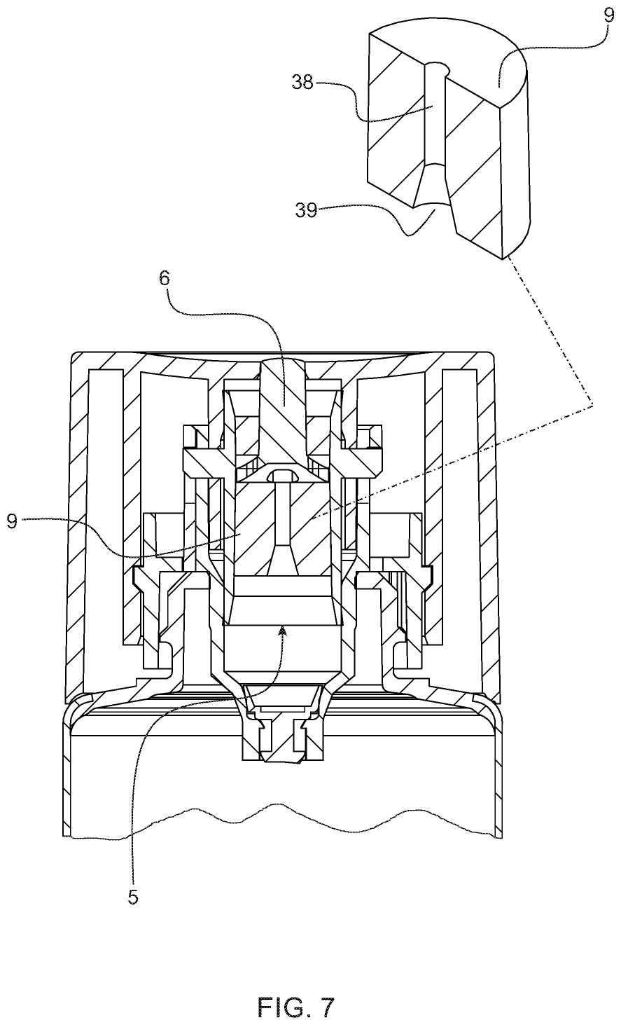

Looking at FIG. 7, the first flow controller (9) is a cylindrical part arranged with interference inside the tubular plunger (5) and below the plug (6), as also said flow controller (9) is vertically leaked by hole (38) inferiorly widened in a frustoconical manner (39), configuring a choked passage for the product to be dispensed. This component constitutes a variable point, especially with regard to the sizing of the hole (38) and taper (39), so that it becomes a component for precise adjustment of the product flow according to its viscosity, making it possible to tailor the assembly to liquid and semi-solid products with a considerable range of viscosity.

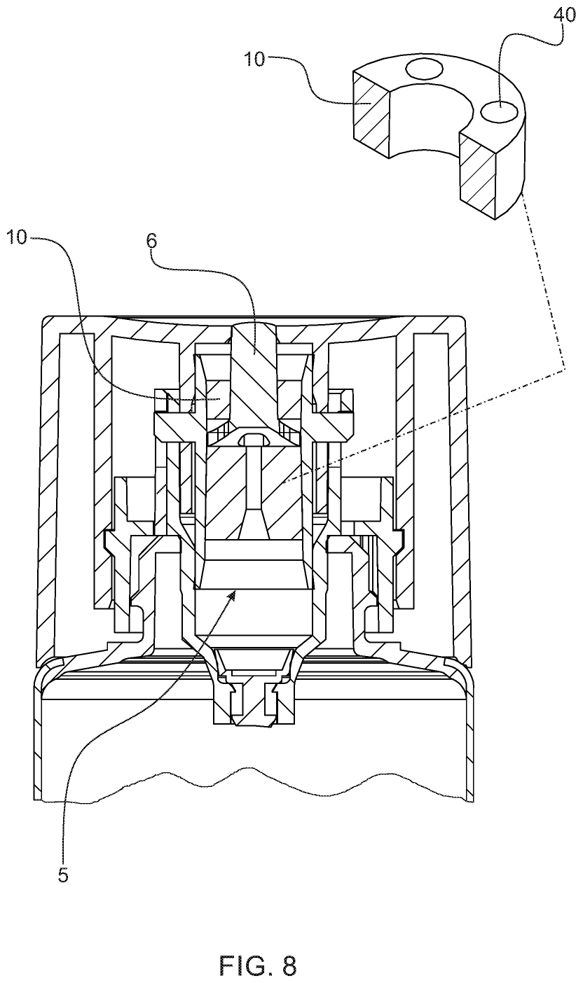

With respect to FIG. 8, the second flow controller (10) is an annular part fitted with interference to the plug (6) and on its base, as well as being leaked by vertical holes (40), which form passages for the product to be dispensed. Similarly to the previous controller (9), this also constitutes a set point and control point of the speed of the product flow, which allows precision in the control of product that is ejected.

Depending on the product contained in the package, the assembly may include the two flow controllers (9) and (10) or include only one of them. Logically such variations depend on the viscosity characteristics of each product.

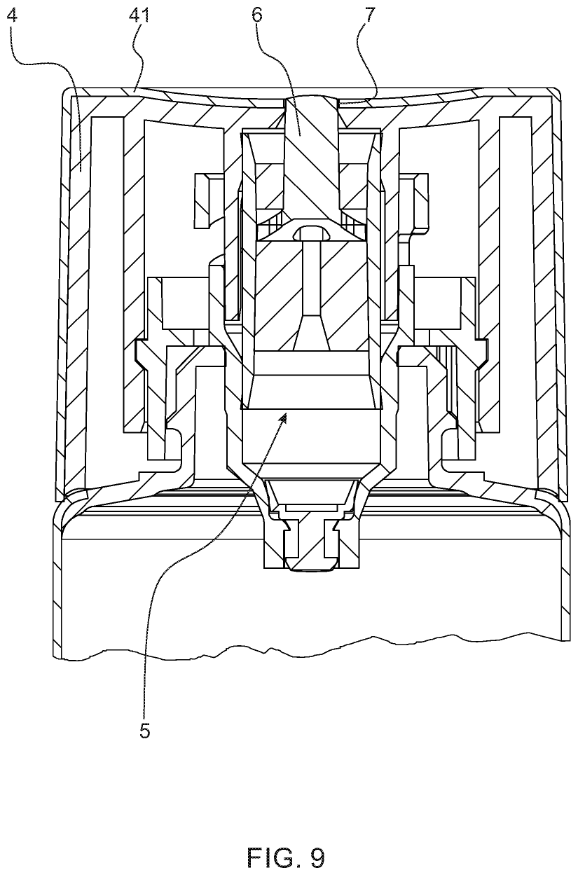

FIG. 9 shows a constructive variation for the cover (4), through which it is verified that it has an outer cover (41) of finishing and that it accompanies its shape, including the hole (7). This finishing cover is made of suitable material to make it possible to offer different finishes for the same cover, which enriches the overall design.

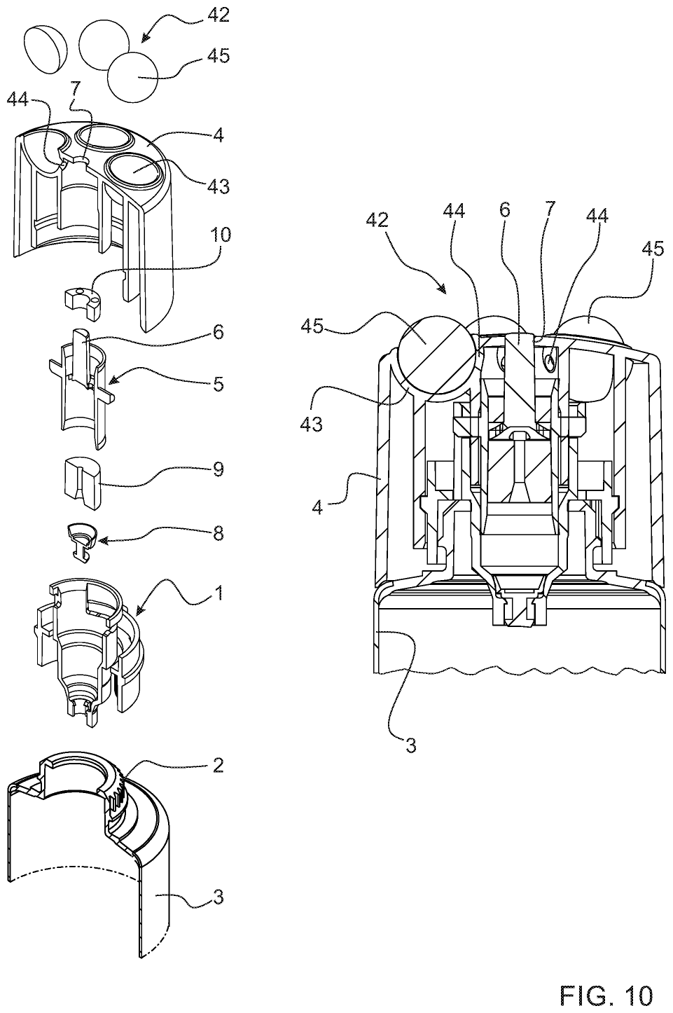

FIG. 10 shows another constructive variation for the cover (4), whereby it is found that it includes a massager (42) formed by several semi-spherical housings (43) around the hole (7), where each housing includes a passing hole (44) for the product, as well as each housing includes retention details for a ball (45), but allowing it to rotate freely in all directions and also present sufficient clearance between it and the corresponding semi-spherical housing (43), so that the dispensed product can be distributed throughout the region of the massager (42) and the latter on the skin of the user.

The operation of the set is the same for the main constructive version and the others. This operation is really very simple, that is, initially the cover (4) is rotated in the direction of opening, consequently, the follower pins (21) slide on the cams (23) which, in addition to limiting this rotation, displaces the plunger (5) downward enough to release the opening (7). Having done this, the tube (3) is gently pressed, at which time an internal pressure action occurs causing the product to be forced against the automatic check valve (8) by displacing it from its sealing seat (20) and, with this, a product flow is established which, in turn, passes through the plunger (5) and through the flow controllers (9) and (10), to then pass through the outlet (7) and accumulate on the recessed part of the cover (4), logically for its ready consumption. The same valve function occurs with the massager (42), however, in this case the product is applied by massages, while in the previous one the dispensed portion is taken with the fingertip and applied in the desired region.

1. VALVED TUBE, comprising:
intermediate mounting body (1), cylindrical, having the lower end fixed to the toothed neck (2) of a known tube (3) of the type manufactured of plastic material with memory to return to its original position when it is no longer pressed;
a cover (4), cylindrical or oval and semi-rotatable in both directions, which encloses and is coupled to the upper side of the intermediate mounting body (1);
tubular plunger (5), whose inner diameter forms a passage chamber for the product, as it is also slidably mounted inside the intermediate mounting body (1) and is interconnected with the cover (4) to be moved up and down;
a plug (6), having its lower end integrated into the inner diameter of the upper end of the tubular plunger (5) and oriented to close or open a hole (7) in the recessed top of the product outlet cover (4);
an automatic check valve (8) mounted on the inner and lower part of the intermediate mounting body (1), wherein said valve opens when there is internal pressure in the tube (3) and closes when it returns to its original position;
a first flow controller (9) disposed within the tubular plunger (5) and below the plug (6); and
a second flow controller (10) disposed at the inter-superior end of the tubular plunger (5) and around the plug (6).

2. VALVED TUBE according to claim 1, wherein said intermediate mounting body (1) consists of a first circular wall (11), whose outer diameter has annular shoulder (12) coupling to the cover (4) and cooperating so that it can undergo semi-rotations in both directions; said intermediate mounting body (1), on the inner side, centers a shell (13) interconnected with the first circular wall (11) by means of another radial wall (14), forming between both a spacing (15) housing of the cover (4); said shell (13) has an intermediate diameter (16) of sliding housing for the tubular plunger (5); a larger upper diameter (17) with means (18) for coupling said tubular plunger (5) and cooperating so that it is moved up and down; and a smaller lower diameter (19), the latter forms an inner seat (20) for the automatic check valve (8).

3. VALVED TUBE according to claim 1, wherein said tubular plunger (5) presents its upper end with two radially opposite projections in the form of follower pins (21), which are coupled to the means (18) of the intermediate body (1) and, to this end, the shell (13) has its inner diameter with relief (22), oppositely located and, in these same regions, the wall of the shell (13) is leaked by tears that form cams (23), symmetrical, with the respective tops (24); said tubular plunger (5) is fitted inside the shell (13), where the follower pins (21) forcibly pass through the relief (22) and are fitted to the cams (23) and, at this point, there is a spacing (25) between the larger upper diameter (17) of the shell (13) and the tubular plunger (5), where coupling occurs between said tubular plunger (5) and the cover (4).

4. VALVED TUBE according to claim 1, wherein said cover (4) consists of three concentric walls, being an outer wall (26), an intermediate wall (27) and an inner wall (28) lower than the previous one, the latter engageable in that spacing (25), as well as having two opposing vertical tears (29), where the pins (21) of the tubular plunger (5) are coupled, while the intermediate wall (27) has its inner diameter equipped with a channel (30) fitting that annular shoulder (12), so that said cover can rotate in both directions, but is prevented from releasing axially.

5. VALVED TUBE according to claim 1, wherein said automatic check valve (8) is formed in a single piece in the form of a cup, defined by a cylindrical central part (31), whose lower end widens and forms a truncated-cone flange shape (32), while the upper end widens in the form of a truncated-cone cup (33), which externally accommodates a sealing annular point (34) formed in the connecting section (35) between diameters (19) and (16) of the intermediate body (1); said sealing seat (20) includes vertical ribs (36), whose upper ends are oriented radially inward and form retaining teeth (37), these with upper inclinations compatible with the tapered diameter of the flange (32), so that it passes between said teeth and is prevented from releasing again, but also between said teeth is positioned the cylindrical central part (31), whose height defines the course that determines the opening and closing of the said automatic check valve (8).

6. VALVED TUBE according to claim 1, wherein said first flow controller (9) is a cylindrical piece arranged with interference inside the tubular plunger (5) and below the plug (6), as well as said flow controller (9) is vertically cast by hole (38) inferiorly trunconically enlarged (39).

7. VALVED TUBE according to claim 1, wherein said second flow controller (10) is an annular piece fitted with interference in the plug (6) and on its base, as it is also leaked by vertical holes (40), which form passages for the product to be dispensed.

8. VALVED TUBE according to claim 1, wherein it includes only one of the two flow controllers (9) and (10).

9. VALVED TUBE according to claim 1, wherein, in a constructive variation, the cover (4) has an outer cover (41) of finishing and that accompanies its shape, including the hole (7).

10. VALVED TUBE according to claim 1, wherein, in another constructive variation, the cover (4) integrates a massager (42) formed by several semi-spherical housings (43) around the hole (7), where each housing includes a hole (44) passing into the product, as well as each housing includes retaining details for a ball (45), but allowing it to rotate freely in all directions and also present sufficient clearance between it and the corresponding semi-spherical housing (43), so that the dispensed product can be distributed throughout the region of the massager (42).
